(19) United States
(12) Patent Application Publication
(10) Pub. No.: US 2010/0172492 A1
(43) Pub. Date: Jul. 8, 2010

(54) METHOD FOR SCHEDULING ELLIPTIC CURVE CRYPTOGRAPHY COMPUTATION

(75) Inventors: JYU YUAN LAI, CHANGHUA COUNTY (TW); CHIH TSUN HUANG, HSINCHU CITY (TW)

Correspondence Address: WPAT, PC;INTELLECTUAL PROPERTY ATTORNEYS, 2030 MAIN STREET, SUITE 1300, IRVINE, CA, 92614, US

(73) Assignee: NATIONAL TSING HUA UNIVERSITY, HSINCHU (TW)

(21) Appl. No.: 12/350,721

(22) Filed: Jan. 8, 2009

(51) Int. Cl. G06F 9/50; H04L 9/28

(52) U.S. Cl. 380/28; 718/104

(57) ABSTRACT

A scheduling method for ECC computation processed in a plurality of arithmetic units comprises a coarse-grained scheduling step for systematically scheduling an ECC computation operation and a fine-grained scheduling step for refining the scheduled ECC computation operation.

### BACKGROUND OF THE INVENTION

(A) Field of the Invention

The present invention relates to a scheduling method, and more particularly, to a method for scheduling an elliptic curve cryptography (ECC) computation process.

(B) Description of the Related Art

As the demand for wired and wireless communication explodes, data security has become an urgent issue for modern vital applications such as financial services, private and healthcare information, personal identification, confidential communication and storage, etc. Among various data security schemes, the public key cryptosystem is robust and effective for secure data transaction and messaging. The robustness typically relies on the difficulty of integer factorization or on finding a discrete logarithm in a finite field.

However, the crucial challenge to implementation of the most popular public-key cryptosystem, RSA cryptography, is the rapid growth of the key length. Therefore, another cryptosystem, ECC, which is based on point operations on elliptic curves over a finite field, either the prime field GF(p) or the binary field GF(2^{m}), has recently been considered as an attractive alternative to RSA. ECC is regarded as mature with higher security with the same key size as that used by most of the traditional public-key cryptosystem.

Among the proposed ECC improvements and architectures, some propose new projective coordinates to effectively reduce the complexity of the elliptic curve arithmetic over GF(2^{m}). Others focus on improving the processing hardware such as introducing a programmable hardware accelerator to speed up point scalar multiplication for specific and generic curves over GF(2^{m}), an FPGA co-processor using a special integer representation to implement point scalar multiplication, a scalable GF(p) ECC architecture with high-radix Montgomery multiplication, a parallel architecture with two multipliers for a specific curve, a low-cost GF(2^{m}) coprocessor with RAM, and a 256-bit ECC processor over GF(p). Other proposed developments focus on improving the algorithm such as introducing an improved Karatsuba multiplication algorithm, a reordered partial multiplication sequence and a pipelined computation of scalar multiplication in the ECC cryptosystem.

However, none of the aforesaid proposals focus on scheduling the ECC computation process. The scheduling method of the present invention not only schedules the ECC computation process, but also schedules via a plurality of arithmetic units (AU) such that the processing time is dramatically reduced.

### SUMMARY OF THE INVENTION

A scheduling method for ECC computation processed in a plurality of arithmetic units according to one embodiment of the present invention comprises the steps of: decomposing arithmetic operations of the ECC computation into atomic finite field operations; determining constraints of the atomic finite field operations, wherein the constraints include start times and required times of the atomic finite field operations, data precedence relation of the atomic finite field operations and the maximum number of operations in each stage of the ECC computation according to the number of the arithmetic units; and establishing the schedule of the ECC computation based on the integer linear programming technique by considering the constraints of the atomic finite field operations.

In some embodiments of the present invention, an operand rescheduling technique is applied to the established schedule of the ECC computation after the aforesaid scheduling method is executed.

In some embodiments of the present invention, an atomic rescheduling technique is applied to the established schedule of the ECC computation after the aforesaid scheduling method is executed.

In some embodiments of the present invention, a loop folding technique is applied to the established schedule of the ECC computation after the aforesaid scheduling method is executed.

A scheduling method for ECC computation processed in a plurality of arithmetic units according to another embodiment of the present invention comprises a coarse-grained scheduling step for systematically scheduling an ECC computation operation and a fine-grained scheduling step for refining the scheduled ECC computation operation.

### BRIEF DESCRIPTION OF THE DRAWINGS

The objectives and advantages of the present invention will become apparent upon reading the following description and upon reference to the accompanying drawings in which:

FIG. 1 shows the flow chart of a scheduling method for ECC computation according to embodiments of the present invention;

FIG. 2 shows a plurality of atomic finite field operations according to an embodiment of the present invention;

FIG. 3 shows the precedence relation of a plurality of atomic finite field operations according to an embodiment of the present invention;

FIG. 4 shows the start times and required times of a plurality of atomic finite field operations according to an embodiment of the present invention;

FIG. 5 shows the equations of a second constraint according to an embodiment of the present invention;

FIG. 6 shows the equations of a third constraint according to an embodiment of the present invention;

FIG. 7 shows a scheduled result according to an embodiment of the present invention;

FIG. 8 shows the flow chart of another scheduling method for ECC computation according to embodiments of the present invention;

FIG. 9 shows another scheduled result according to an embodiment of the present invention;

FIG. 10 shows another scheduled result according to an embodiment of the present invention; and

FIG. 11 shows another scheduled result according to an embodiment of the present invention.

### DETAILED DESCRIPTION OF THE INVENTION

Embodiments of the present invention will now be described more fully with reference to the accompanying drawings. The present invention may, however, be embodied in many different forms and should not be construed as limited to the embodiments set forth herein. Rather, these embodiments are provided so that this disclosure will be thorough and complete, and will fully convey the scope of the present invention to those skilled in the art.

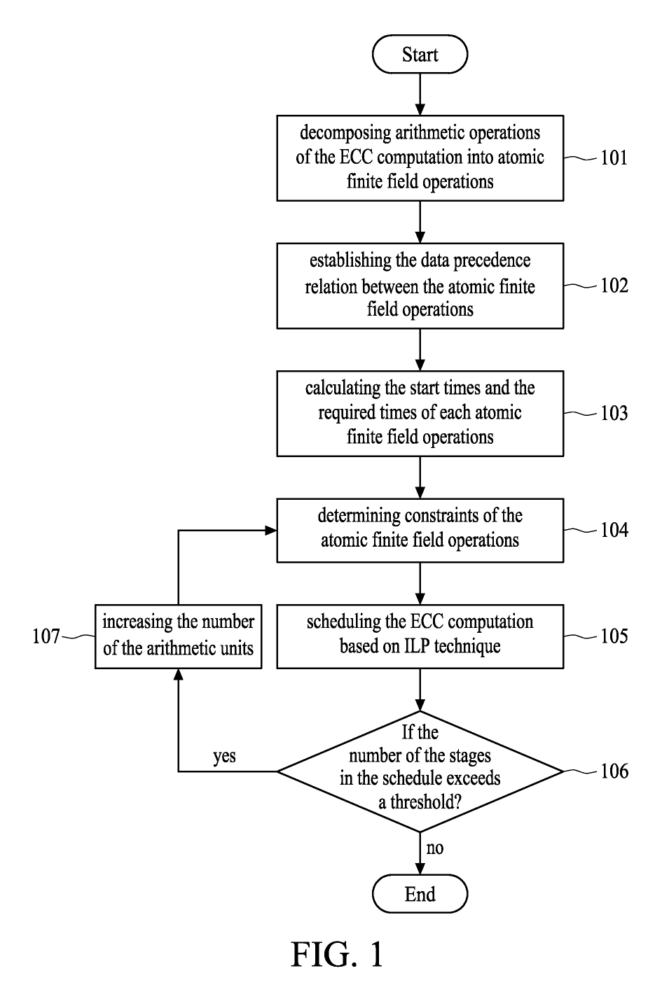

FIG. 1 shows the flow chart of a scheduling method for ECC computation according to embodiments of the present invention. In step 101, arithmetic operations of the ECC computation are decomposed into atomic finite field operations. In Step 102, the data precedence relation between the atomic finite field operations is established. In Step 103, the start times and the required times of each atomic finite field operation are calculated. In Step 104, constraints of the atomic finite field operations such as the start times and required times, the data precedence relation and the maximum number of operations in each stage of the ECC computation according to the number of the arithmetic units are determined. In Step 105, the ECC computation is scheduled based on the integer linear programming (ILP) technique by considering the constraints of the atomic finite field operations. In Step 106, the number of stages in the schedule is checked. If the number of stages in the schedule exceeds a threshold value, Step 107 is executed. Otherwise, the scheduling process is finished. In Step 107, the number of the arithmetic units is increased, and Step 104 is executed.

In one embodiment of the present invention, a part of the elliptic curve point arithmetic over GF(p) of the ECC computation is listed as follows:

x₂=p−(x₀z₁²+x₁z₀²)(x₀z₁²−x₁z₀²)², and z₂=z₀z₁(x₀z₁²−x₁z₀²).

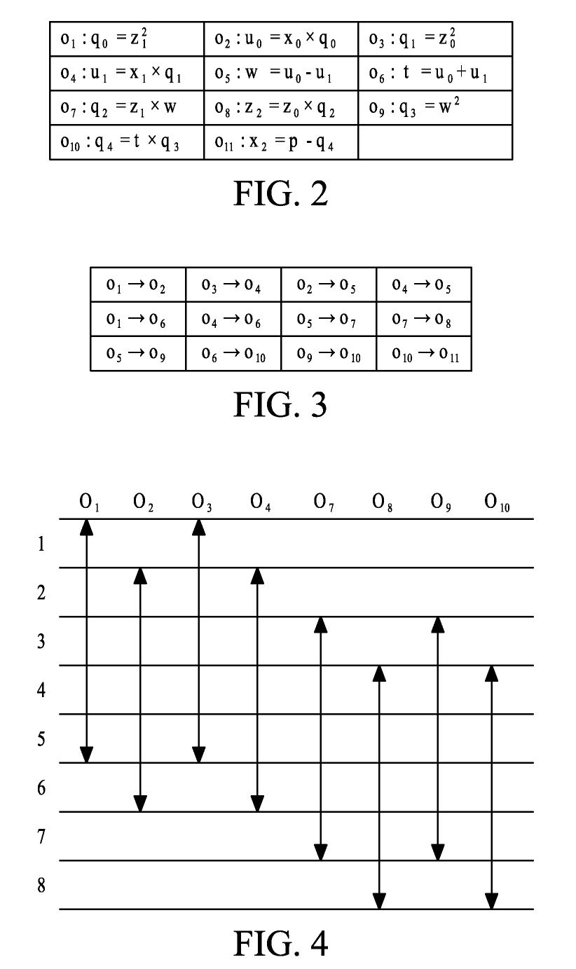

Following Step 101 in FIG. 1, these two arithmetic operations are decomposed into eleven atomic finite field operations oᵢ, 1≦i≦11, as shown in FIG. 2. Following Step 102, the data precedence relation is established as shown in FIG. 3 according to the atomic finite field operations. Following Step 103, the start times and the required times of each atomic finite field operation are calculated as shown in FIG. 4 according to the data precedence relation. For example, operation o₂ should not be started before the second stage and should be finished no later than the sixth stage. It can be seen that in this embodiment, the finite field addition and subtraction are omitted during the scheduling procedure since they serve minor roles compared with the multiplication operations. That is, o₅, o₆ and o₁₁ are omitted as shown in FIG. 4, while the data precedence relation is still maintained. Following Step 104, constraints of the atomic finite field operations are determined. The first constraint, also shown in FIG. 4, describes the stages of each atomic finite field operation to be executed, and is shown as follows:

$${\sum }_{j = {s}_{i}}^{{r}_{i}} {x}_{i , j} = 1 , ∀ 1 \leq i \leq n ,$$

where sᵢ denotes the start time, or the start stage, rᵢ denotes the required time, x_{i,j} is a zero-one variable, and n is the number of the atomic finite field operations, which is 11 as shown in FIG. 2. That is, if oᵢ is scheduled in stage m, then x_{i,m}=1 and x_{i,j}=0 for j≠m.

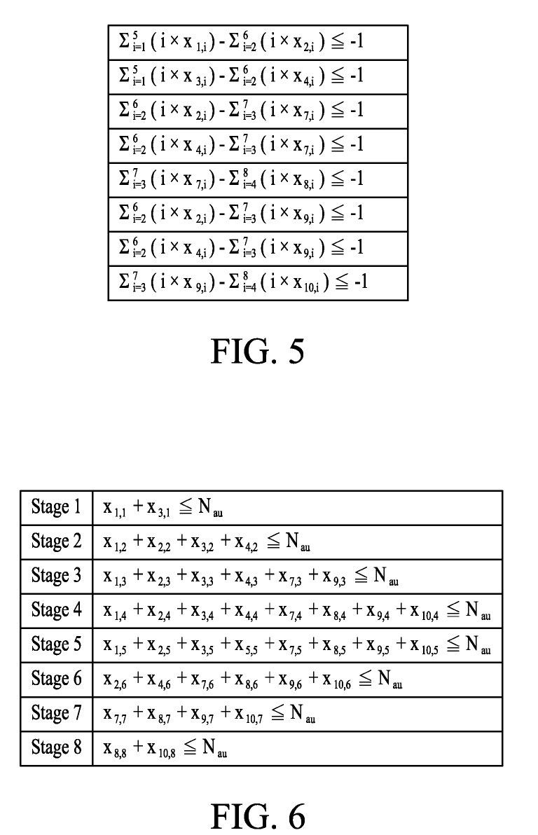

The second constraint ensures that the data precedence relations are preserved, and is shown as follows:

$${\sum }_{j = {s}_{i}}^{{r}_{i}} ( j \times {x}_{i , j} ) - {\sum }_{j = {s}_{k}}^{{r}_{i}} ( j \times {x}_{k , j} ) \leq - K , ∀ {o}_{i} \to {o}_{k} ,$$

where K is the number of stages required for executing oᵢ. In this embodiment, each operation takes one stage and therefore K is assigned as 1. FIG. 5 shows the equations according to the second constraint. Taking the first equation in FIG. 5 for example,

$${\sum }_{j = 1}^{5} ( j \times {x}_{1 , j} ) - {\sum }_{j = 2}^{6} ( j \times {x}_{2 , j} ) \leq - 1$$

indicates that o₁ should be executed before o₂ for at least one stage ahead.

The third constraint describes the number of operations in each stage of the ECC computation according to the number of arithmetic units, and is shown as follows:

$${\sum }_{i = 1}^{n} {x}_{i , j} \leq {N}_{au ,} ∀ 1 \leq j \leq {N}_{s} ,$$

where Nₐᵤ denotes the number of arithmetic units and Nₛ denotes the number of stages after the scheduling. FIG. 6 shows the equations according to the third constraint.

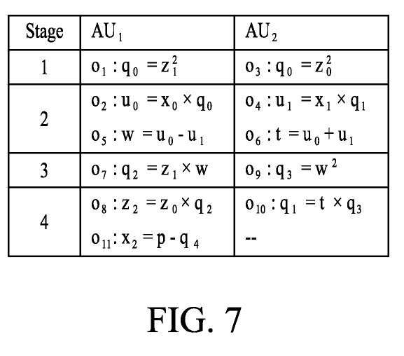

Following Step 105, the ECC computation is scheduled based on the ILP technique based on the constraint equations shown above, wherein the initial Nₐᵤ is 1. After the scheduled process, eight stages are required to perform the ECC computation, while the threshold in Step 106 is 4. Therefore, Nₐᵤ is incremented to 2, and Steps 104 to 106 are re-executed. FIG. 7 shows the scheduled result based on the ILP technique for Nₐᵤ being 2. As can be seen in FIG. 7, the total required stages is 4, the number of stages does not exceed the threshold value, and the omitted finite field addition and subtraction operations are inserted back into the schedule.

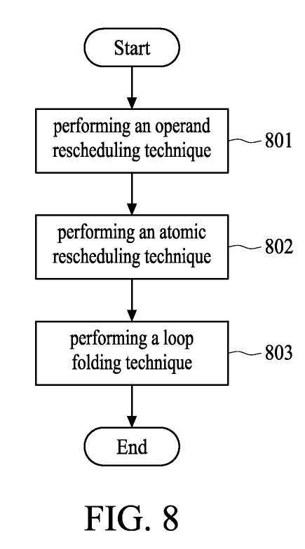

In some embodiments of the present invention, after performing the scheduling method shown in FIG. 1, the ECC computation is further refined by utilizing other scheduling methods. FIG. 8 shows a flow chart of another scheduling method for ECC computation according to embodiments of the present invention. In Step 801, the operand rescheduling technique is performed. That is, each atomic finite field operation is checked to determine whether it can be combined with the following atomic finite field operation to further reduce redundant operations. In Step 802, the atomic rescheduling technique is performed. That is, each atomic finite field operation is checked to determine whether it can be shifted to another stage and executed by another arithmetic unit to further reduce the number of stages required by the ECC computation. In Step 803, the loop folding technique is performed. That is, each atomic finite field operation is checked to determine whether it can be shifted to the same stage and executed by another arithmetic unit in a different iteration to further reduce the number of stages required by the ECC computation.

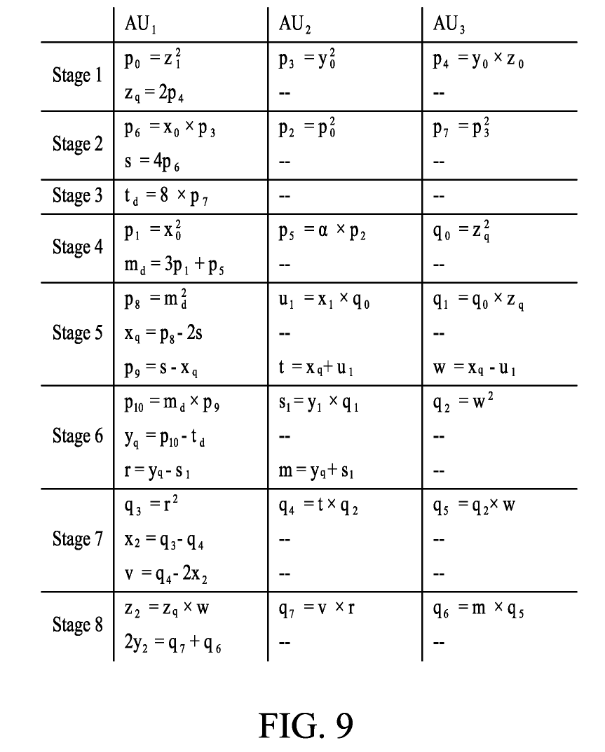

FIG. 9 shows a scheduled result of an ECC computation after performing the scheduling method shown in FIG. 1 according to another embodiment of the present invention. The ECC computation is based on the standardized elliptic curve over GF(p) as follows y₂=x³+αx+β, where x, y∈GF(p) and β≠0. Following Step 801, the operand rescheduling technique is performed. As shown in FIG. 9, the first arithmetic unit in the last stage produces 2y₂, wherein the result y₂ is then substituted as y₀ in the next iteration. From the scheduled result shown in FIG. 9, it can be deduced that since p₃=y₀², p₆=x₀p₃ and s=4p₆, then s=4x₀y₀²=x₀(2y₀)². Therefore, 2y₂ is substituted as y₀ in the next iteration instead of dividing 2y₂ by 2 to produce y₂ in the last stage, and the operation of multiplying by 4 as indicated by s=4P₆ can be omitted.

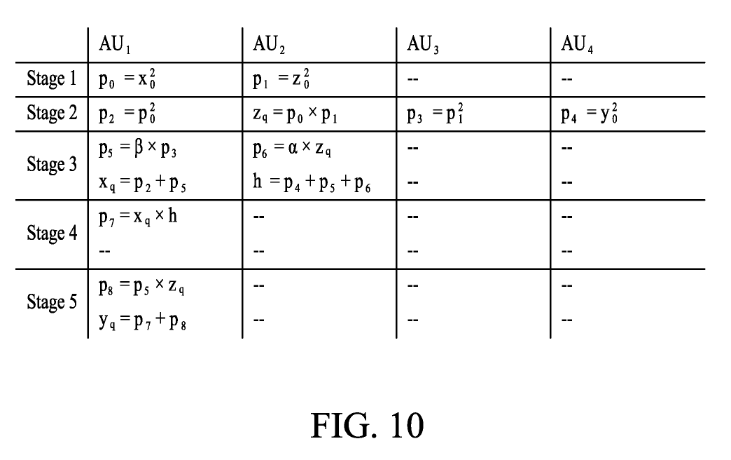

FIG. 10 shows a scheduled result of an ECC computation after performing the scheduling method shown in FIG. 1 according to another embodiment of the present invention. The ECC computation is based on the standardized elliptic curve over GF(2^{m}) as follows y²+xy=x³+αx²+β, where x, y∈GF(2^{m}) and β≠0. Following Step 802, the atomic rescheduling technique is performed. As shown in FIG. 10, the first arithmetic unit in the fifth stage executes the operations of P₈=p₅z_{q} and y_{q}=p₇+p₈, while the second arithmetic unit is idle in the fourth stage. Therefore, the operations of the production of p₈ and y_{q} are shifted from the fifth stage by the first arithmetic unit to the fourth stage by the second arithmetic unit, while the precedence relation remains the same. It can be seen that the number of stages is reduced from 5 to 4 after the atomic rescheduling technique is performed.

Following the scheduling result of FIG. 10, Step 803 is executed to further reduce the amount of stages of the ECC computation. As shown in

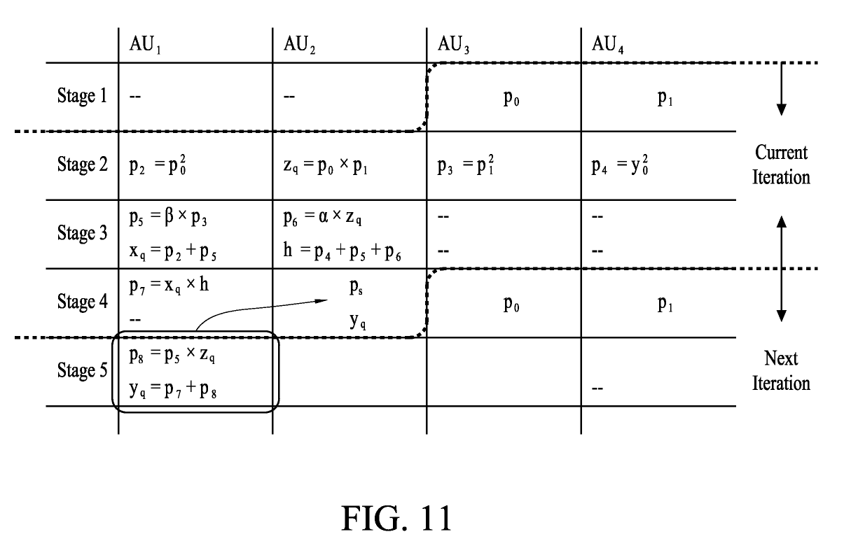

FIG. 10, the third and fourth arithmetic units are idled in the first stage and the fourth stage. Therefore, after executing Step 803, the operations in the first stage by the first and second arithmetic units are shifted to the third and fourth arithmetic units, as shown in FIG. 11. That is, two consecutive iterations, such as the operations in the fourth stage by the first and second arithmetic units in the current iteration and the operations in the first stage by the third and fourth arithmetic units in the next iteration, can be overlapped in one stage. It can be seen that the effective number of stages for one iteration is reduced from 4 to 3 after the loop folding technique is performed.

In conclusion, the scheduling methods according to embodiments of the present invention schedule the ECC computation process via a plurality of arithmetic units such that the ECC arithmetic over both GF(p) and GF(2^{m}) are both optimized. In addition, in some embodiments of the present invention, a coarse-grained scheduling method, such as the method shown in FIG. 1, is first applied to an ECC computation operation. Afterward, a fine-grained scheduling method, such as the method shown in FIG. 8, is further applied to and refines the scheduled ECC computation operation.

The above-described embodiments of the present invention are intended to be illustrative only. Those skilled in the art may devise numerous alternative embodiments without departing from the scope of the following claims.

What is claimed is:

1. A scheduling method for elliptic curve cryptography (ECC) computation processed in a plurality of arithmetic units (AUs), the scheduling method comprising the steps of:
decomposing arithmetic operations of the ECC computation into atomic finite field operations;
determining constraints of the atomic finite field operations, wherein the constraints include start times and required times of the atomic finite field operations, data precedence relation of the atomic finite field operations and the maximum number of operations in each stage of the ECC computation according to the number of AUs; and
establishing a schedule of the ECC computation based on the integer linear programming (ILP) technique by considering the constraints of the atomic finite field operations.

2. The scheduling method of claim 1, further comprising the step of:
increasing the number of AUs and executing the step of determining constraints of the atomic finite field operations if the total number of stages of the established schedule exceeds a threshold number.

3. The scheduling method of claim 1, wherein addition and subtraction operations of the atomic finite field operations are omitted during the establishment of the schedule of the ECC computation, and the addition and subtraction operations are reinserted into the stages of the schedule after establishing the schedule of the ECC computation, while the data precedence relation is maintained.

4. The scheduling method of claim 1, further comprising the step of:
applying an operand rescheduling technique to the established schedule of the ECC computation.

5. The scheduling method of claim 4, wherein for the applied atomic finite field operation, the operand rescheduling technique is to combine the atomic finite field operation with the following atomic finite field operation.

6. The scheduling method of claim 1, further comprising the step of:
applying an atomic rescheduling technique to the established schedule of the ECC computation.

7. The scheduling method of claim 6, wherein for the applied atomic finite field operation, the atomic rescheduling technique is to shift the atomic finite field operation to another stage executed by another arithmetic unit.

8. The scheduling method of claim 1, further comprising the step of:
applying a loop folding technique to the established schedule of the ECC computation.

9. The scheduling method of claim 8, wherein for the applied atomic finite field operation, the loop folding technique is to shift the atomic finite field operation to the same stage executed by another arithmetic unit in the next iteration.

10. A scheduling method for elliptic curve cryptography (ECC) computation processed in a plurality of arithmetic units (AUs), the scheduling method comprising the steps of:
a coarse-grained scheduling step for systematically scheduling an ECC computation operation; and
a fine-grained scheduling step for refining the scheduled ECC computation operation.
